(19) United States
(12) Patent Application Publication
(10) Pub. No.: US 2013/0150197 A1
(43) Pub. Date: Jun. 13, 2013

(54) POWER STRUCTURE OF HYBRID SYSTEM

(71) Applicants: Jong Ho Lee, Hwaseong-si (KR); Seok Joon Kim, Yongin-si (KR)

(72) Inventors: Jong Ho Lee, Hwaseong-si (KR); Seok Joon Kim, Yongin-si (KR)

(73) Assignee: Hyundai Motor Company, Seoul (KR)

(21) Appl. No.: 13/536,441

(22) Filed: Jun. 28, 2012

(30) Foreign Application Priority Data
Dec. 12, 2011 (KR) 10-2011-0132962

(51) Int. Cl. F16H 37/06

(52) U.S. Cl. 475/5; 903/903; 903/902; 180/65.22

(57) ABSTRACT

Provided is a power structure of a hybrid system. In particular, the power structure of a hybrid system includes a planetary gear part including a sun gear, a carrier, and a ring gear, a first motor connected with the sun gear, a second motor connected with the ring gear, an engine and a brake connected with the carrier to drive a hybrid car by two motors at the time of EV traveling, thereby improving traveling performance and increase an EV region without increasing the motor size, thereby improving fuel efficiency.

### CROSS-REFERENCE TO RELATED APPLICATION

The present application claims priority to Korean Patent Application No. 10-2011-0132962, filed on Dec. 12, 2011 in the Korean Intellectual Property Office, the entire contents of which is incorporated herein for all purposes by this reference.

### BACKGROUND OF THE INVENTION

1. Field of the invention

The present invention relates to a power structure of a hybrid system, and more particular, to a power structure of a hybrid system increasing an electric vehicle (EV) traveling speed without increasing a motor size of a hybrid car to improve fuel efficiency.

2. Description of Related Art

Generally, a hybrid car is configured to include an engine, an electric motor, and a battery and is configured to approximate a working point of an engine to an optimal operating line at which fuel consumption is minimal by a power assisted electric motor at the time of accelerating a vehicle so as to improve fuel efficiency.

The hybrid car is classified into a serial type hybrid car operating an electric motor using power generated by allowing an engine to drive a generator and a parallel type hybrid car reducing a burden of an engine by allowing an electric motor to share a burden of an engine.

Meanwhile, describing power transmission of a hybrid car according to the related art, power of a driving shaft of an engine is transmitted to a sun gear and a ring gear via a carrier of a planetary gear that includes the sun gear, the carrier, and the ring gear.

In this case, the power transmitted to the sun gear drives a generator and the power generated from the generator operates a driving motor or is charged in a battery.

Further, a torque of the ring gear and a driving force of the driving motor are coupled with each other by a final drive to rotate wheels mounted at both sides of the final drive.

However, the hybrid car according to the related art has a limitation in operating a driving motor, which leads to degradation in traveling performance.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a power structure of a hybrid system, and in particular, to increase EV traveling speed without increasing a motor size of a hybrid car to improve fuel efficiency.

In an aspect of the present invention, a power structure of a hybrid system, may include a planetary gear part including a sun gear, a carrier, and a ring gear, a first motor connected with the sun gear, a second motor connected with the ring gear, an engine and a brake connected with the carrier.

The first motor is directly connected with the sun gear and the second motor is directly connected with the ring gear.

The first motor is a motor/generator.

When a vehicle is in an EV (Electric Vehicle) mode, the first motor serves as a motor, and when the vehicle enters into an HEV (Hybrid Electric Vehicle) mode, the first motor and the second motor each serve as a generator and a motor.

The first motor and the second motor are electrically connected with a battery.

The second motor is connected with a drive coupled with wheels of a vehicle.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram showing a power structure of a hybrid system according to an exemplary embodiment of the present invention.

FIG. 2 is a configuration diagram showing a power flow of a power structure of a hybrid system according to various exemplary embodiments of the present invention.

FIG. 3 is a configuration diagram showing a power flow of a power structure of a hybrid system according to various exemplary embodiments of the present invention.

FIG. 4 is a configuration diagram showing a power flow of a power structure of a hybrid system according to various exemplary embodiments of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

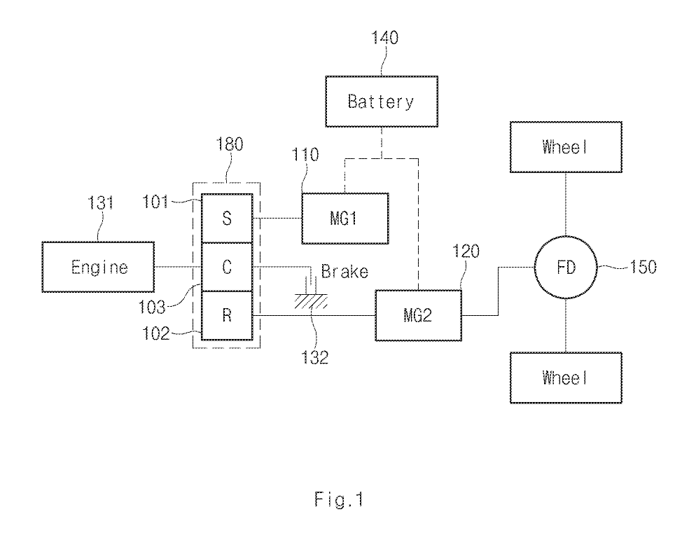

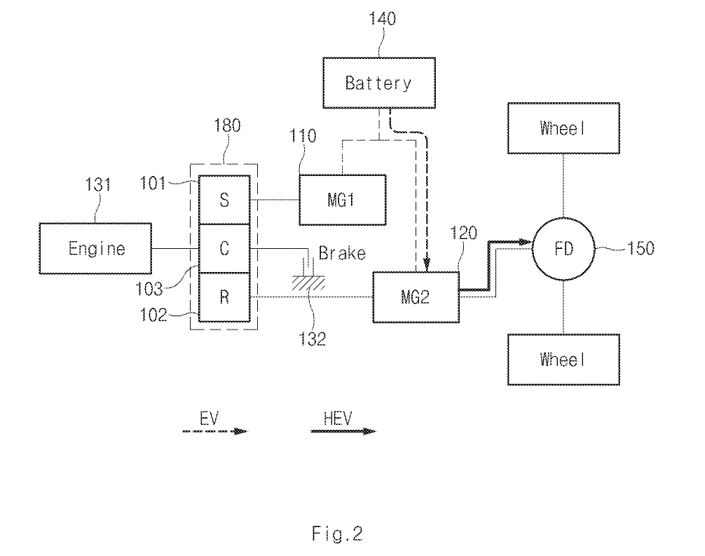

FIGS. 1 to 4 relate to a power structure of a hybrid system according to an exemplary embodiment of the present invention, wherein FIG. 1 is a configuration diagram showing a power structure of a hybrid system according to an exemplary embodiment of the present invention and FIGS. 2 to 4 are configuration diagrams showing a power flow of a power structure of a hybrid system according to an exemplary embodiment of the present invention.

Exemplary embodiments of the present invention will be described in detail with reference to the accompanying drawings.

As shown in FIGS. 1 to 4, a power structure of a hybrid system according to an exemplary embodiment of the present invention includes a first motor 110 connected with a sun gear 101 of a planetary gear part 180, a second motor 120 connected with a ring gear 102, and an engine 131 and a brake 132 connected with a carrier 103 to improve traveling performance of a hybrid car.

Hereinafter, each component of the power structure of the hybrid system according to the exemplary embodiment of the present invention will be described with reference to the accompanying drawings.

First, the exemplary embodiment of the present invention includes a planetary gear part 180. The sun gear 101, the ring gear 102, and the carrier 103 of the planetary gear part 180 are connected with the first motor 110, the second motor 120, the engine 131, and the brake 132 and the second motor 120 connected with the ring gear 102 is connected with a drive 150 to output power.

As shown in FIG. 1, the planetary gear part 180 is configured to include the sun gear 101, the carrier 103, and the ring gear 102.

The first motor 110 is connected with the sun gear 101 rather than with an input part and an output part in the planetary gear part 110 including the sun gear 101, the carrier 103, and the ring gear 102.

The second motor 120 is connected with the ring gear 102 that is the output part and is connected with the drive 150 to be described below.

In this configuration, the first motor 110 and the second motor 120 mounted in the hybrid car controls an engine optimal working point that is the largest advantage of the hybrid system. The exemplary embodiment of the present invention may include two motors to control the working point, thereby improving traveling performance.

The carrier 103, which is the input part, is connected with the engine 131 generating power of a vehicle body to receive the power of the engine 131.

Further, the carrier 103 is also connected with the brake 132 and controls the driving of the first motor 110 connected with the sun gear 101 and the second motor 120 connected with the ring gear 102.

Meanwhile, the first motor 110 and the second motor 120 may be connected with a battery 140 to operate the first motor 110 and the second motor 120.

Further, the second motor 120 connected with the ring gear 102 that is the output part is connected with the drive 150 connecting wheels of a vehicle to transmit power output through the ring gear 102 to the drive 150, thereby driving the vehicle.

Hereinafter, in the power structure of the hybrid system according to the exemplary embodiment of the present invention, each mode conversion will be described below.

FIG. 2 is a diagram showing a power flow at the time of starting an engine in an EV mode. The hybrid car is traveled in an EV mode that directly transmits power of a motor at the time of starting an initial vehicle. In this case, the first motor 110 rotates in unload in the state in which the engine 131 stops during the EV mode without generating power. Meanwhile, when the engine starts to be driven in a hybrid electric vehicle (HEV) mode during the traveling of the EV mode, the first motor 110 is converted into a generator to increase the engine 131 to an engine starting tolerable speed and then, start the engine 13.

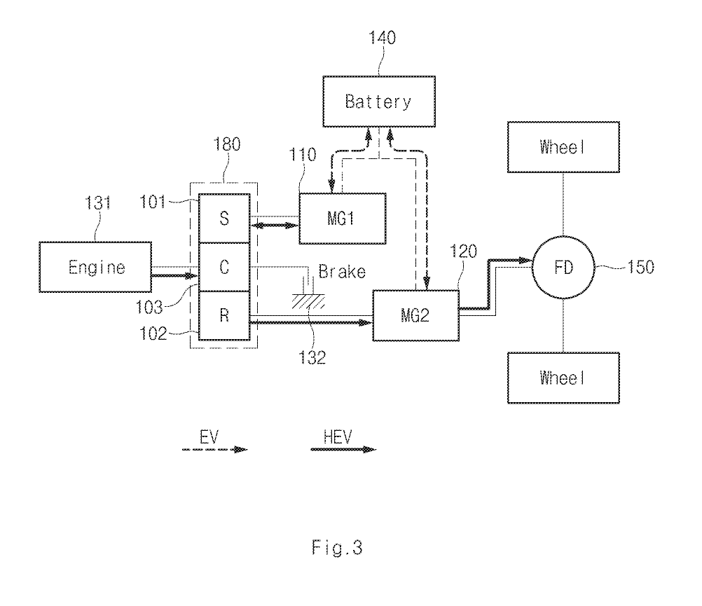

FIG. 3 is a diagram showing a power flow at the time of converting the EV mode into the HEV mode. When entering into the HEV mode after the engine 131 starts, the first motor 110 and the second motor 120 each serve as a generator and a motor to perform a control to drive E-CVT, that is, the engine working point at the optimal working point. Meanwhile, the second motor 120 is directly connected with the output part and thus, mainly serves as a motor to assist power.

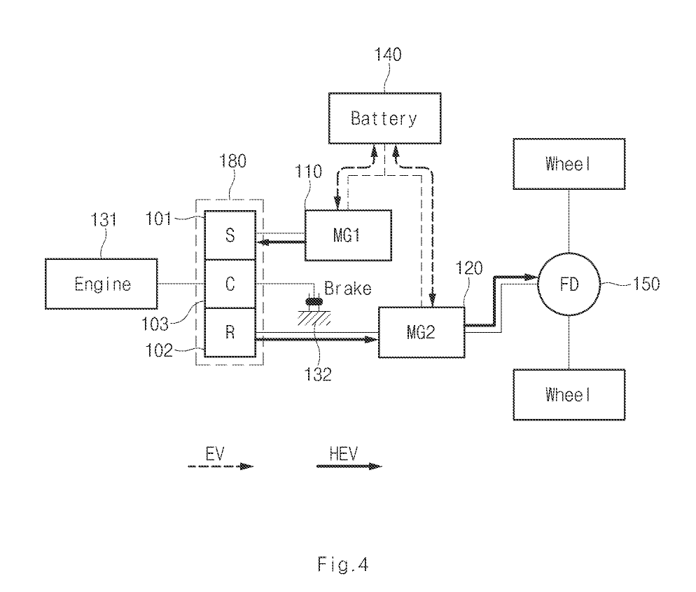

FIG. 4 is a diagram showing a power flow at the time of converting the EV mode into another EV mode. When only the second motor 120 is driven in the EV mode, a speed of the second motor 120 is excessive due to grading situation or an increased vehicle speed, which results in operating the brake 132 in the case of undertorque so as to be driven in another EV mode. Meanwhile, both of the first motor 110 and the second motor 120 may be used as a power source. Here, when the conversion into an opposite mode is made, a control is performed to minimize the impact caused at the time of the mode conversion by concentrating the torque dispersed into the first motor 110 and the second motor 120 to the second motor 120 and then, releasing the brake 132.

As described above, the exemplary embodiment of the present invention can drive the EV system by using the first motor 110, the second motor 120, and the brake 132 to improve the traveling performance and increase the EV tolerable vehicle speed, thereby improving the fuel efficiency.

The power structure of the hybrid system of the exemplary embodiment of the present invention configured as described above is configured to include: the planetary gear part including the sun gear, the carrier, and the ring gear, the first motor connected with the sun gear, the second motor connected with the ring gear, the engine and the brake connected with the carrier to drive the hybrid car by two motors at the time of the EV traveling, thereby improving the traveling performance and increase the EV region without increasing the motor size, thereby improving the fuel efficiency.

As set forth above, the exemplary embodiments of the present invention can drive the hybrid car by two motors at the time of the EV traveling to improve the traveling performance and can increase the EV region without increasing the motor size to improve the fuel efficiency.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A power structure of a hybrid system, comprising:
a planetary gear part including a sun gear, a carrier, and a ring gear;
a first motor connected with the sun gear;
a second motor connected with the ring gear; and
an engine and a brake connected with the carrier.

2. The power structure of the hybrid system according to claim 1, wherein the first motor is directly connected with the sun gear and the second motor is directly connected with the ring gear.

3. The power structure of the hybrid system according to claim 1, wherein the first motor is a motor/generator.

4. The power structure of the hybrid system according to claim 3, wherein:
when a vehicle is in an EV (Electric Vehicle) mode, the first motor serves as a motor; and
when the vehicle enters into an HEV (Hybrid Electric Vehicle) mode, the first motor and the second motor each serve as a generator and a motor.

5. The power structure of the hybrid system according to claim 1, wherein the first motor and the second motor are electrically connected with a battery.

6. The power structure of the hybrid system according to claim 1, wherein the second motor is connected with a drive coupled with wheels of a vehicle.
